(19) United States
(12) Patent Application Publication
(10) Pub. No.: US 2015/0100322 A1
(43) Pub. Date: Apr. 9, 2015

(54) REMOTE CONTROL APPARATUS FOR INPUTTING USER VOICE AND METHOD THEREOF

(71) Applicant: SAMSUNG ELECTRONICS CO., LTD., Suwon-si (KR)

(72) Inventors: Tae-young LEE, Suwon-si (KR); Cheul-hee HAHM, Seongnam-si (KR)

(73) Assignee: SAMSUNG ELECTRONICS CO., LTD., Suwon-si (KR)

(21) Appl. No.: 14/250,507

(22) Filed: Apr. 11, 2014

(30) Foreign Application Priority Data
Oct. 7, 2013 (KR) 10-2013-0118966

(51) Int. Cl. G10L 17/22; G06F 3/01

(52) U.S. Cl. CPC G10L 17/22; G06F 3/017
USPC 704/275

(57) ABSTRACT

A remote control apparatus is disclosed. The remote control apparatus includes a movement detector which is configured to detect a movement of the remote control apparatus, a microphone which is configured to receive a voice input, a controller which is configured to activate the microphone in response to the remote control apparatus moving for a preset first time by at least a threshold angle, and a communicator which is configured to transmit the voice input to an external device in response to the voice input being input through the activated microphone.

### CROSS-REFERENCE TO RELATED APPLICATIONS

This application claims priority from Korean Patent Application No. 10-2013-0118966, filed on Oct. 7, 2013, in the Korean Intellectual Property Office, the disclosure of which is incorporated by reference in its entirety.

### BACKGROUND

1. Field

Exemplary embodiments relate to a remote control apparatus for inputting a user voice and a method thereof. In particular, exemplary embodiments relate to a remote control apparatus for inputting a user voice, which is activated according to use intention and receiving the user voice, and a method thereof.

2. Description of the Related Art

Various types of electronic products have been developed and are becoming popular. Further, various interaction technologies have been used for a user to easily use and interact with these electronic products.

In the related art, an interaction technology may be, for example, a remote control apparatus. The remote control apparatus of the related art is a control apparatus which controls an electronic product spaced apart from the user. When the user pushes a button included in the remote control apparatus of the related art, the remote control apparatus transmits a control signal corresponding to the button to an external electronic product. The electronic product receiving the control single performs an operation corresponding to the control signal. For example, with regard to a television (TV), when the user pushes a power button of the remote control apparatus, the TV is turned on. In this case, the user may use various functions such as channel selection or volume control.

In some cases, an electronic product of the related art may also be configured to be manipulated via a voice control or a motion control, in addition to the related art normal button manipulation. For example, a display apparatus such as a TV may be configured to recognize a user voice and provide a corresponding interactive service. In this scenario of the related art, a microphone is used to receive the user voice.

However, when a user voice is input through a microphone in the related art, surrounding sounds may also be input together with the user voice. Accordingly, an unintended error may occur in the related art.

Accordingly, there is a need for a technology which is more effective for receiving a user voice to control a device.

### SUMMARY

Exemplary embodiments may overcome the above disadvantages and other disadvantages not described above. Also, the exemplary embodiments are not required to overcome the disadvantages described above, and an exemplary embodiment may not overcome any of the problems described above.

The exemplary embodiments provide a remote control apparatus for inputting user voice and a method thereof, which effectively receives a user voice and transmits the user voice to a display apparatus.

According to an aspect of an exemplary embodiment, a remote control apparatus includes a movement detector which is configured to detect a movement of the remote control apparatus, a microphone which is configured to receive a voice input, a controller which is configured to activate the microphone in response to the remote control apparatus moving for a preset first time by at least a threshold angle, and a communicator which is configured to transmit the voice input to an external device in response to the voice input being through the activated microphone.

The controller may be further configured to inactivate the microphone in response to the voice input not being input for a preset second time when the microphone is activated.

The controller may be further configured to inactivate the microphone in response to the remote control apparatus being restored to a state before the movement of the remote control apparatus occurs.

The remote control apparatus may further include a detector which is configured to detect a use intention with respect to the remote control apparatus, wherein the controller may be further configured to inactivate the movement detector in a standby state, and activate the movement detector in response to the use intention being detected.

The detector may be further configured to detect at least one of a user touch on the remote control apparatus, a user approach to the remote control apparatus, a button input, and a preset user motion, and the controller may be further configured to determine that there is the use intention in response to at least one of the user touch on the remote control apparatus, the user approach to the remote control apparatus, the button input, and the preset user motion occurring.

The remote control apparatus may further include a proximity detection sensor which is disposed at one side of the microphone and configured to detect a user approach to the remote control apparatus, wherein the controller may be further configured to activate the microphone in response to the proximity detection sensor detecting the user approach and the remote control apparatus moving for a first time by at least the threshold angle.

The communicator may include a Bluetooth module, and the controller may be further configured to set an operation mode of the Bluetooth module to a first operation mode for energy saving in a standby state, set the operation mode of the Bluetooth module to a second operation mode for transmitting button manipulation information in response to the microphone being inactivated, and set the operation mode of the Bluetooth module to a third operation mode for transmitting button manipulation information and input voice information in response to the microphone being activated.

The remote control apparatus may further include a display unit, wherein the controller may be further configured to activate the microphone in response to the remote control apparatus rotating by at least the threshold angle for the preset first time in a direction away from a surface of the remote control apparatus, on which the display unit is disposed.

The controller may be further configured to activate the microphone in response to the remote control apparatus rotating by at least the threshold angle for the preset first time in a direction away from a surface of the remote control apparatus, on which the microphone is disposed.

According to another aspect of an exemplary embodiment, a voice inputting method of a remote control apparatus includes detecting a movement of the remote control apparatus using a sensor included in the remote control apparatus, activating a microphone in response to the remote control apparatus moving for a preset first time by at least a threshold angle, and transmitting a voice input through the microphone to an external device.

The method may further include inactivating the microphone in response to the voice not being input for a preset second time when the microphone is activated.

The method may further include inactivating the microphone in response to the remote control apparatus being restored to a state before the movement of the remote control apparatus occurs.

The method may further include detecting a use intention with respect to the remote control apparatus, and inactivating the sensor in a standby state, and activating the sensor to detect movement of the remote control apparatus in response to the use intention being detected.

The detecting the use intention may include determining that there is the use intention in response to at least one of a user touch on the remote control apparatus, a user approach to the remote control apparatus, a button input, and a preset user motion occurring.

The remote control apparatus may include a Bluetooth module; and the method may further include setting an operation mode of the Bluetooth module to a first operation mode for energy saving in a standby state, setting the operation mode of the Bluetooth module to a second operation mode for transmitting button manipulation information in response to the microphone being inactivated, and setting the operation mode of the Bluetooth module to a third operation mode for transmitting button manipulation information and input voice information in response to the microphone being activated.

The remote control apparatus may include a display unit, and the activating the microphone may include activating the microphone in response to the remote control apparatus rotating by at least the threshold angle for the preset first time in a direction away from a surface of the remote control apparatus, on which the display unit is disposed.

The activating of the microphone may include activating the microphone in response to the remote control apparatus rotating by the at least the threshold angle for the preset first time in a direction away from a surface of the remote control apparatus, on which the microphone is disposed.

According to the aforementioned exemplary embodiments, the remote control apparatus may effectively receive a user voice according to a use intention of a user, thereby preventing an unpredicted error.

According to another aspect of an exemplary embodiment, a voice inputting method of a remote control apparatus including a Bluetooth module and a microphone includes detecting a standby state in which the remote control apparatus is not being used, setting an operation of the Bluetooth module to an energy saving operation in response to detecting the standby state; detecting an activation state of the microphone in response to not detecting the standby state; setting an operation of the Bluetooth module to a button manipulation operation in response to detecting the microphone being inactivated.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWINGS

The above and/or other aspects of the exemplary embodiments will be more apparent by describing certain exemplary embodiments with reference to the accompanying drawings, in which:

FIG. 1 is a diagram illustrating a remote control system according to an embodiment;

FIG. 2 is a block diagram illustrating a structure of a remote control apparatus according to an embodiment;

FIG. 3 is a diagram illustrating an example of a reference axis for detection of movement of a remote control apparatus according to an embodiment;

FIG. 4 is a diagram illustrating a control method using a remote control apparatus;

FIG. 5 is a flowchart for explanation of a voice inputting method according to an embodiment;

FIG. 6 is a block diagram illustrating a structure of a remote control apparatus according to another embodiment;

FIG. 7 is a diagram illustrating a structure of an appearance of a remote control apparatus according to another embodiment;

FIG. 8 is a flowchart for explanation of a voice input method according to another embodiment;

FIG. 9 is a flowchart for explanation of a communication method of remote control apparatus according to another embodiment;

FIG. 10 is a diagram for explanation of an example of a method using a conversation service using a remote control apparatus;

FIG. 11 is a block diagram illustrating a display apparatus according to an embodiment;

FIG. 12 is a diagram illustrating an example of an operation of a display apparatus that operates in conjunction with a state of a remote control apparatus; and

FIG. 13 is a diagram illustrating a structure of a remote control apparatus for displaying a message indicating a state of a microphone unit.

### DETAILED DESCRIPTION OF THE EXEMPLARY EMBODIMENTS

Certain exemplary embodiments will now be described in greater detail with reference to the accompanying drawings.

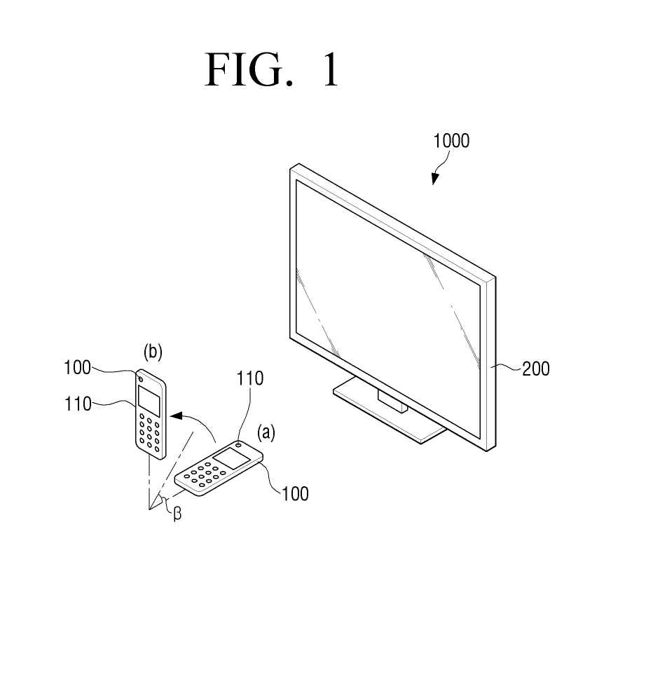

FIG. 1 is a diagram illustrating a remote control system 1000 according to an embodiment. Referring to FIG. 1, the remote control system 1000 includes a remote control apparatus 100 and a display apparatus 200. The display apparatus 200 may be embodied as various types of devices such as a television (TV), a monitor, a laptop personal computer (PC), a portable phone, a personal digital assistant (PDA), an electronic picture frame, a kiosk, etc. Although FIG. 1 exemplifies the display apparatus 200, the following embodiments may be applied to various electronic products (e.g., an air conditioner, a refrigerator, an audio system, a washing machine, a cleaner, etc.) in addition to a display apparatus.

As illustrated in FIG. 1, the remote control apparatus 100 may be provided for control of the display apparatus 200. Various input units such as buttons may be provided in the remote control apparatus 100. A user may manipulate a button to control an operation of the display apparatus 200. In addition, a unit for receiving a voice, such as a microphone unit 110 may be provided in the remote control apparatus 100.

The user may use a voice input service through the microphone unit 110 of the remote control apparatus 100. The voice input service may include a voice control service used by pronouncing a predetermined voice command, a conversation service for conversation with the display apparatus 200 by pronouncing a non-determined random text, etc.

When the microphone unit 110 of the remote control apparatus 100 is always in an active state, an error may occur due to ambient noise. Further, unnecessary power consumption may be caused by the microphone unit 110. Accordingly, in a remote control system 1000 of FIG. 1, the microphone unit 110 may be activated only when a preset condition is satisfied. In addition, even if the condition is satisfied, when the microphone unit 110 is not used or a preset inactivation condition is satisfied, the remote control apparatus 100 automatically inactivates the microphone unit 110. In addition, conditions for activating and inactivating the microphone unit 110 may be set in various ways according to embodiments.

Upon satisfying a condition in which the remote control system 1000 moves within a preset time by a preset threshold angle, the microphone unit 110 may be activated. The time may be set by the user or may be unit time set as a default time. For convenience the preset time is referred to as a first time. The first time may be counted from a point when the remote control apparatus 100 is held or initially begins move. The first time may be set in various ways. For example, the first time may be set to 1 second, but is not limited thereto.

On the other hand, upon satisfying a condition in which the remote control system 1000 is restored to an original state, the microphone unit 110 may be inactivated. In addition, when voice is not input for predetermined time, the microphone unit 110 may be inactivated again. For convenience, the predetermined time may be a second time. The second time may also be determined according to a user setting or a default value. For example, the second time may be set to be longer than the first time (e.g., 30 seconds), but exemplary embodiments are not limited thereto.

FIG. 1 illustrates a case in which the microphone unit 110 is activated upon satisfying a condition in which the user holds the remote control apparatus 100 and raises the remote control apparatus 100 by a preset threshold angle (β) or more.

When the remote control apparatus 100 is not used, the remote control apparatus 100 may be positioned almost parallel to a ground surface (a). In addition, in order to control the display apparatus 200 by pushing a button of the remote control apparatus 100, a front end portion of the remote control apparatus 100 may be directed toward the display apparatus 200. Accordingly, when the remote control apparatus 100 is not used or is used via button manipulation, the remote control apparatus 100 is not largely inclined with respect to a ground surface.

When the user wants to input a voice using the remote control apparatus 100, the user needs to bring the microphone unit 110 of the remote control apparatus 100 toward a lip of the user. Accordingly, when the microphone unit 110 is positioned at a front end portion or front upper portion of the remote control apparatus 100, the remote control apparatus 100 is positioned perpendicular to a ground surface (b).

Accordingly, based on movement of the remote control apparatus 100, the microphone unit 110 may be activated or inactivated. For example, when the user raises the remote control apparatus 100 by a preset threshold angle (β) or more, the microphone unit 110 is activated. Further, when the remote control apparatus 100 is restored to an original state, the microphone unit 110 is inactivated.

When the microphone unit 110 is activated, if a user voice is input to the remote control apparatus 100, the remote control apparatus 100 transmits the user voice to an external display apparatus 200. Accordingly, a voice recognition service may be provided.

In addition to a case in which the remote control apparatus 100 is restored to an original state, when the remote control apparatus 100 is not used for predetermined time, the microphone unit 110 may also be inactivated.

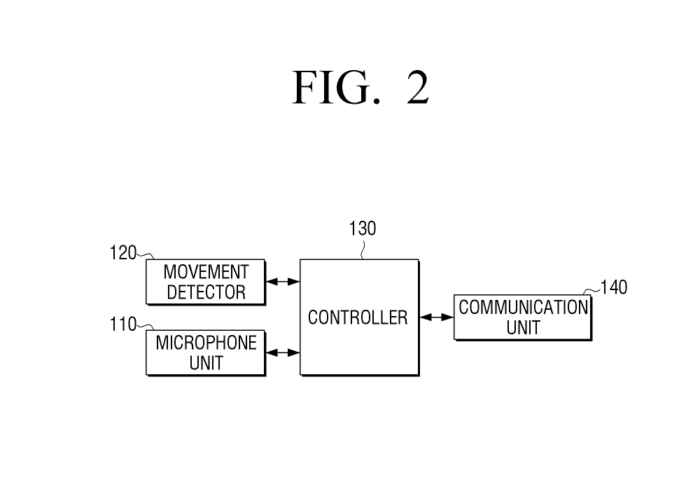

FIG. 2 is a block diagram illustrating a structure of the remote control apparatus 100 according to an embodiment. Referring to FIG. 2, the remote control apparatus 100 includes the microphone unit 110, a movement detector 120, a controller 130, and a communication unit 140. At least one of the microphone unit 110, the movement detector 120, the controller 130, and the communication unit 140 may include at least one processor.

The microphone unit 110 is a component for receiving voice input. The microphone unit 110 may include various components such as a microphone for collecting user voice in analog form, an amp circuit for amplifying the collected user voice, an analog/digital (A/D) converting circuit for sampling the amplified user voice and converting the user voice into a digital signal, a filter circuit for removing noise components from the converted digital signal, etc. The type, size, position, etc., of the microphone may be changed according to a type of an operation to be executed via the remote control apparatus 100, an appearance of the remote control apparatus 100, a usage type of the remote control apparatus 100, etc. For example, when the remote control apparatus 100 has a hexahedral shape having a rectangular front surface, the microphone of the microphone unit 110 may be disposed at the front surface of the remote control apparatus 100.

The movement detector 120 is a component for detection of movement of the remote control apparatus 100. The movement detector 120 may be embodied as various types of sensors such as a geomagnetic sensor, an acceleration sensor, a gyro sensor, etc. With regard to the geomagnetic sensor, the movement detector 120 may measure an electrical signal corresponding to geomagnetism of an environment where the remote control apparatus 100 is used to calculate a rotational angle. With regard to the acceleration sensor, the movement detector 120 may measure inclination of the remote control apparatus 100 to calculate a pitch angle and/or a roll angle. With regard to the gyro sensor, the movement detector 120 may measure an angular velocity according to movement of the remote control apparatus 100 to calculate a rotational angle.

Movement detected by the movement detector 120 is provided to the controller 130. The controller 130 determines whether the movement of the remote control apparatus 100 satisfies a preset condition. For example, when a threshold angle is set, if the remote control apparatus 100 moves or rotates by the threshold angle or more, the controller 130 may determine that the condition is satisfied.

When the detected movement satisfies the preset condition, the controller 130 activates the microphone unit 110. Accordingly, the microphone unit 110 may receive a user voice (as described above).

The communication unit 140 may transmit voice input through the microphone unit 110 to an external device. In some embodiments, the communication unit 140 may transmit a voice pronounced by the user, or a control code corresponding to the voice.

The controller 130 may re-inactivate the microphone unit 110 when the microphone unit 110 is activated and voice is not input for a preset time. When an amplitude of the electrical signal converted by the microphone unit 110 is less than a preset value, the controller 130 determines a current period as a silent period in which the user voice is not input. When the silent period is equal to or greater than the preset time, the controller 130 inactivates the microphone unit 110.

When it is determined that the remote control apparatus 100 moves in an opposite direction and restores an original state, the controller 130 may deactivate the microphone unit 110. Activation and deactivation may correspond to a turn-on and a turn-off operation. In other words, the controller 130 may stop supplying power to the microphone unit 110 from a battery (not shown). Therefore, an operation of the microphone unit 110 is inactivated. When the condition is satisfied, the controller 130 may supply power to the microphone unit 110 to activate the microphone unit 110. However, activation and inactivation methods are not limited thereto. In other words, some components of the microphone unit 110 may turn on and turn off for activation and inactivation. Further, a cover of the microphone unit 110 may be opened and closed for activation and inactivation.

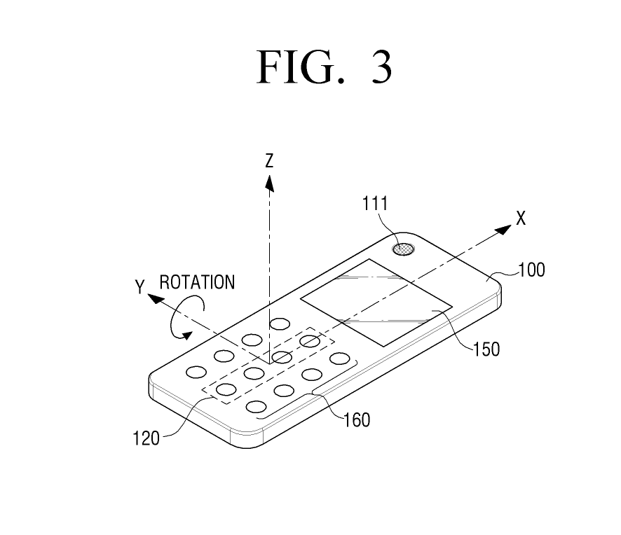

FIG. 3 is a diagram illustrating an example of an appearance of the remote control apparatus 100. Referring to FIG. 3, a microphone 111, a display unit 150, buttons 160, etc., may be provided on a front surface of the remote control apparatus 100. The microphone 111 may be disposed on various portions, such as an upper portion, an intermediate portion, or a lower portion of the front surface. FIG. 3 illustrates a case in which the microphone 111 is disposed on the upper portion of the display unit 150 so as to not overlap the buttons 160.

As illustrated in FIG. 3, when the microphone 111 is disposed on the upper portion of the front surface (e.g., the microphone 111 is not hidden by the user hand while the remote control apparatus 100 is held by the user), voice may be more accurately input. In addition, the remote control apparatus 100 may further include the display unit 150. In this case, the user may conveniently input voice while viewing the display unit 150.

FIG. 3 illustrates a case in which the movement detector 120 is embodied as one acceleration sensor. An example of the acceleration sensor may include a 2-axis acceleration sensor, a 3-axis acceleration sensor, and the like. A detection reference axis of the movement detector 120 may be changed according to an arrangement direction of the movement detector 120. For example, X, Y, and Z axes may be illustrated in FIG. 3.

For example, when the movement detector 120 uses a 2-axis acceleration sensor, the movement detector 120 may include X-axis and Y-axis acceleration sensors (not shown) perpendicular to each other. In this case, the movement detector 120 may normalize output values of X-axis and Y-axis acceleration sensors according to Equation 1 below, and then calculates a pitch value and a roll value using the normalized value

$${Xt}_{norm} = \frac{( Xt - {Xt}_{offset} )}{{Xt}_{Scale}} \\ {Yt}_{norm} = \frac{( Yt - {Yt}_{offset} )}{{Yt}_{Scale}} \\ {Xt}_{offset} = \frac{{Xt}_{max} + {Xt}_{min}}{2} , {Xt}_{Scale} = \frac{{Xt}_{max} - {Xt}_{min}}{2} \\ {Yt}_{offset} = \frac{{Yt}_{max} + {Yt}_{min}}{2} , {Yt}_{Scale} = \frac{{Yt}_{max} - {Yt}_{min}}{2} \qquad [ Equation 1 ]$$

In Equation 1, Xt and Yt are output values of X-axis and Y-axis acceleration sensors, respectively. Xtnorm and Ytnorm are normalized values of the X-axis and Y-axis acceleration sensors, respectively. Xtmax and Xtmin are a maximum value and minimum value of Xt, respectively. Ytmax and Ytmin are a maximum value and minimum value of Yt, respectively. Xtoffset and Ytoffset are offset values of the X-axis and Y-axis acceleration sensors, respectively. XtScale and YtScale are scale values of the X-axis and Y-axis acceleration sensors, respectively. Xtoffset, Ytoffset, XtScale, and YtScale may be pre-calculated while the remote control apparatus 100 included in the movement detector 120 rotates in each axis direction several times and may be stored in an internal memory (not shown) of the movement detector 120 or an internal memory (not shown) of the remote control apparatus 100.

The movement detector 120 may normalize output values of the X-axis and Y-axis acceleration sensors using the stored offset values and scale values. The movement detector 120 may insert the normalized value of each axis acceleration sensor into Equation 2 below to calculate a pitch angle and a roll angle.

$$θ = {sin}^{- 1} ( {Xt}_{norm} ) \\ φ = {sin}^{- 1} ( \frac{{Yt}_{norm}}{cos θ} ) \qquad [ Equation 2 ]$$

In Equation 2 above, θ is a pitch angle and φ is a roll angle.

The movement detector 120 may provide the calculated pitch angle and roll angle to the controller 130.

When the microphone 111 is disposed on the upper portion of the front surface of the remote control apparatus 100, if the user brings the microphone 111 toward the lip of the user in order to input voice, the remote control apparatus 100 rotates toward a surface of the display unit 150. In other words, in FIG. 3, the remote control apparatus 100 rotates around a Y axis and a pitch angle is changed. Accordingly, in this case, among the aforementioned pitch angle and roll angle, the roll angle does not have to be calculated, and only the pitch angle may be calculated and used as a reference for determination of the movement. When the pitch angle is about 0°, the controller 130 determines that the remote control apparatus 100 is in a horizontal state. When a preset threshold angle is 30°, if the pitch angle increases to 30° or more, the controller 130 may activate the microphone unit 110. The threshold angle may be set to various values.

When the user holds the remote control apparatus 100 so as to position the front surface of the remote control apparatus 100 in parallel to a perpendicular direction to the display apparatus 200, if the user brings the microphone 111 toward the lip of the user, the remote control apparatus 100 rotates around an X axis and the roll angle is changed. In this case, the controller 130 may determine whether the condition is satisfied using only the roll angle without the pitch angle.

In addition, when the remote control apparatus 100 rotates by a threshold angle or more for the preset first time in a direction away from a surface of the remote control apparatus 100, on which a microphone is disposed, the controller 130 may also activate the microphone unit 110. In other words, in some cases, the user may raise the remote control apparatus 100 and move the microphone unit 110 toward the lip of the user.

In addition, with regard to the geomagnetic sensor or the gyro sensor, the remote control apparatus 100 may sense a rotational angle at which the remote control apparatus 100 vertically rotates and determine whether the condition is satisfied based on the rotational angle.

As described above, movement of the remote control apparatus 100 may be determined based on various values such as a pitch angle, a roll angle, a rotation angle, etc.

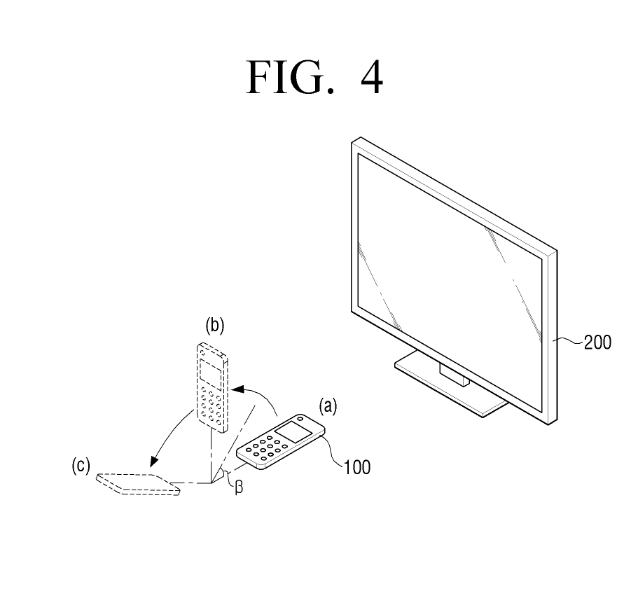

FIG. 4 is a diagram illustrating a method using the remote control apparatus 100 of FIG. 3. A user 10 may use the remote control apparatus 100 while changing his or her posture in various ways, such as a sitting posture, a standing posture, a lying posture, etc.

When the remote control apparatus 100 is not used or buttons are manipulated, the remote control apparatus 100 is positioned in parallel to a ground surface, as illustrated in (a) of FIG. 4. When the user 10 wants to input a voice while sitting or standing, the user 10 raises the remote control apparatus 100 and brings the remote control apparatus 100 toward the lip of the user. In this case, as illustrated in (b) of FIG. 4, the remote control apparatus 100 moves by a threshold angle β or more. Accordingly, the controller 130 activates the microphone unit 110.

When the user 10 wants to input voice while lying, the remote control apparatus 100 rotates until a front surface of the remote control apparatus 100 faces a ground surface, as illustrated in (c) of FIG. 4. In this case, the controller 130 also activates the microphone unit 110 since the remote control apparatus 100 moves by the threshold angle β.

When the remote control apparatus 100 moves by the threshold angle β, the controller 130 may store information about a state such as a pitch angle, a roll angle, etc., just before the movement occurs, or information about a movement direction, a movement angle, etc., in a random access memory (RAM) or other memories. Accordingly, when the remote control apparatus 100 moves in an opposite direction by a similar angle, the controller 130 may deactivate the microphone unit 110.

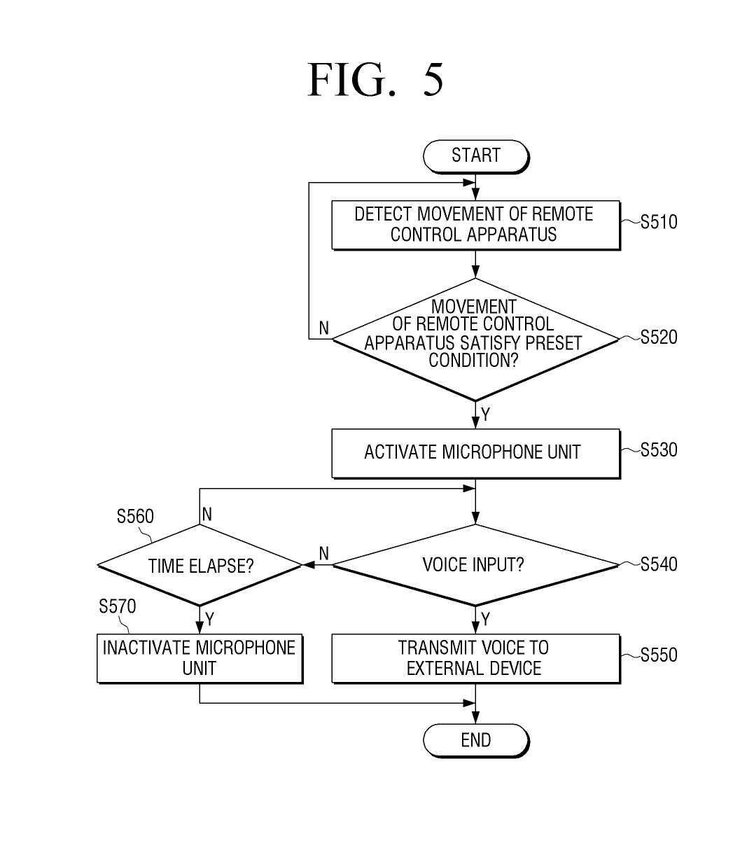

FIG. 5 is a flowchart for explanation of a voice inputting method of a remote control apparatus according to an embodiment. Referring to FIG. 5, the remote control apparatus detects its movement (S510) and determines whether the movement satisfies a preset condition (S520).

As a determination result, when the movement satisfies the condition, the remote control apparatus 100 activates the microphone unit 110 (S530). The condition may be a condition in which the remote control apparatus 100 moves by a preset threshold angle or more (as described above), or a condition in which a pitch angle, a roll angle, a rotation angle, a yaw angle, etc., of the remote control apparatus 100 is within a preset angle. Further, conditions appropriate for a posture adopted by the user, while the user holds the remote control apparatus 100 in order to input the user voice, may be experimentally measured and set.

When the microphone unit 110 is activated, voice is input to the microphone unit 110, and the remote control apparatus 100 transmits the input voice to an external device, that is, the display apparatus 200. When the predetermined time elapses while the microphone unit 110 is activated and voice is not input (S560), the remote control apparatus 100 inactivates the microphone unit 110 (S570).

Whenever a user voice is input, the remote control apparatus updates standby time. Accordingly, when the preset time elapses from a point when the last voice is input, the microphone unit 110 is inactivated.

According to the aforementioned embodiment, when the user does not use the remote control apparatus 100, the remote control apparatus 100 maintains a state in which the microphone unit 110 is inactivated. Therefore, ambient noise or other noises are prevented from being input as a voice.

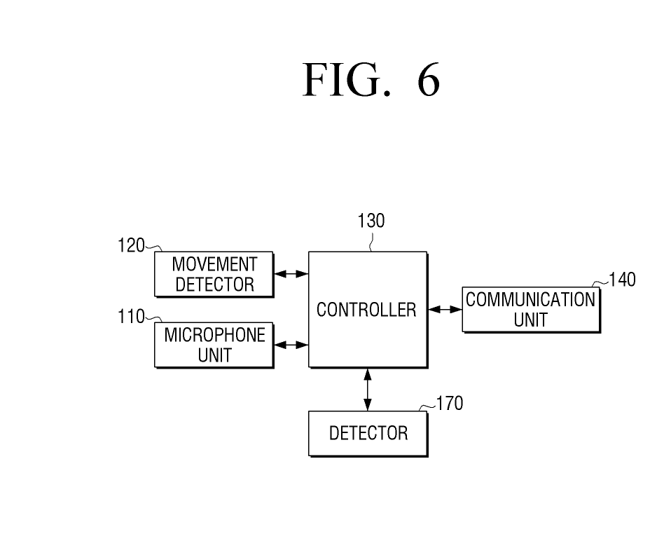

FIG. 6 is a block diagram illustrating a structure of a remote control apparatus according to another embodiment. Referring to FIG. 6, the remote control apparatus 100 includes the microphone unit 110, the movement detector 120, the controller 130, the communication unit 140, and a detector 170.

The detector 170 is a component for detecting a use intention of a user with respect to the remote control apparatus 100. The detector 170 always maintains an activation state when the remote control apparatus 100 is turned on. Further, even if the remote control apparatus 100 is turned on, the remaining components may be inactivated in a standby state in which the remote control apparatus 100 is not used.

For example, the movement detector 120, the microphone unit 110, the communication unit 140, and so on may be inactivated in a standby state.

When the use intention is detected by the detector 170, the controller 130 activates the movement detector 120. Thus, when the activated movement detector 120 detects movement of the remote control apparatus 100, the controller 130 determines whether the movement satisfies a preset condition. When the movement satisfies the condition, the controller 130 activates the microphone unit 110, receives a voice, and transmits the voice to an external device through the communication unit 140.

The detector 170 may detect use intention via various methods.

For example, the detector 170 may include a touch sensor, a proximity detection sensor, a motion detection sensor, a button, and so on to detect the use intention of the user. When the detector 170 is embodied as a touch sensor, if the controller 130 detects a user touch on the remote control apparatus 100, the controller 130 may determine that there is use intention. When the detector 170 is embodied as a proximity detection sensor, if the controller 130 detects a user approach to the remote control apparatus, the controller 130 may determine that there is use intention. When the detector 170 is embodied as a button, the controller 130 may determine that there is use intention while the button is selected or within a predetermined time after the selection. When the detector 170 is embodied as a motion detection sensor, if the controller 130 detects that the user adopts a specific motion corresponding to a voice input mode, the controller 130 may determine that there is use intention. In addition, when the detector 170 may be embodied as an acceleration sensor and the movement detector 120 may be geomagnetic sensor or a gyro sensor.

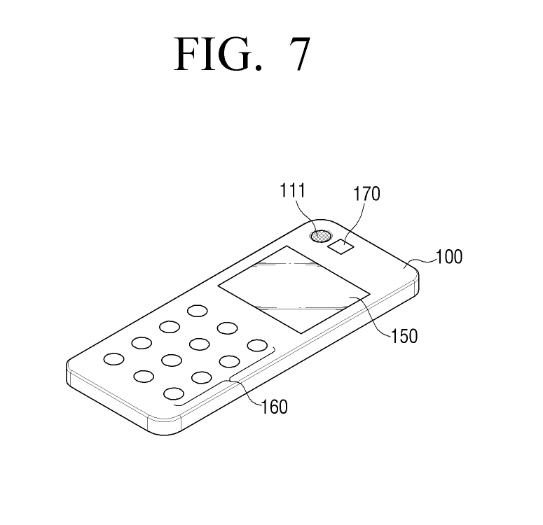

FIG. 7 illustrates an example of a case in which a detector is embodied as a proximity detection sensor 170. Referring to FIG. 7, the proximity detection sensor 170 is disposed at one side of a microphone included in the microphone unit 110 and detects a user approach. When the microphone 111 and the proximity detection sensor 170 are disposed, when a user hand is stretched toward the remote control apparatus 100 or brings the remote control apparatus 100 towards the lip of the user, user approach is detected to activate the movement detector 120. In this state, when the remote control apparatus 100 is erected, the microphone unit 110 is activated to complete a voice input preparation.

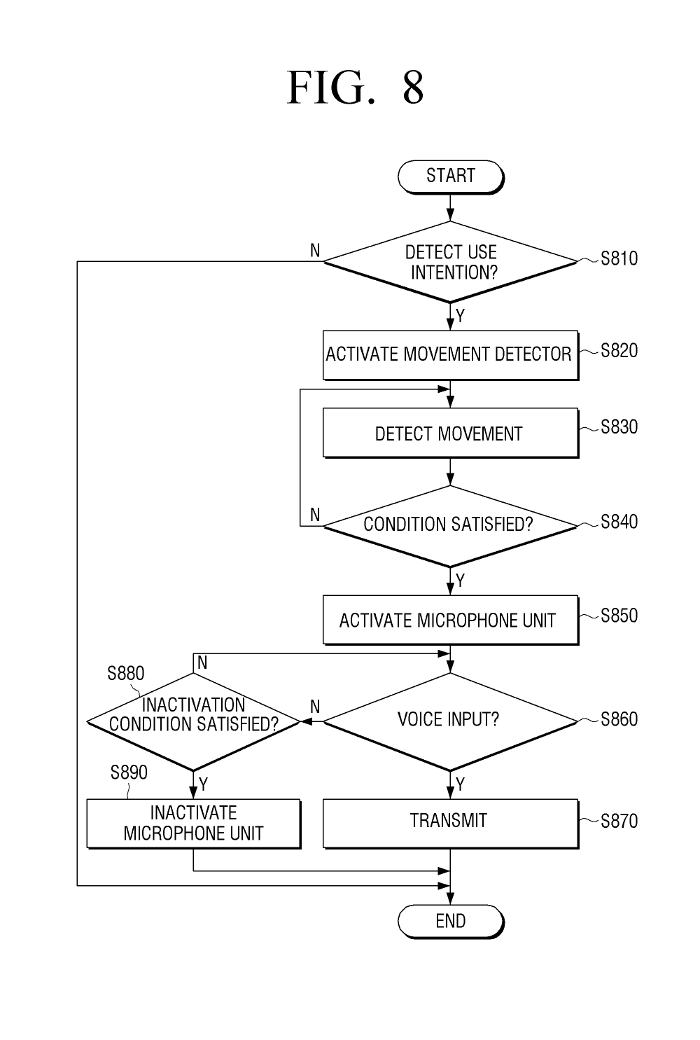

FIG. 8 is a flowchart for explanation of a voice input method according to an embodiment. Referring to FIG. 8, when the remote control apparatus 100 detects use intention of a user (S810), the remote control apparatus 100 activates a movement detector (S820). Then, when movement of the remote control apparatus 100 is detected (S830), it is determined whether the movement satisfies a preset condition (S840).

As a determination result, when the condition is satisfied, a microphone unit is activated (S850). Further, when the condition is not satisfied, the microphone unit is maintained in an inactivation state.

When the microphone unit is activated, if a user pronounces a voice, the voice is input to the microphone unit 110 (S860). The remote control apparatus 100 transmits the input voice to an external device (S870).

After the microphone unit is activated, when an inactivate condition, in which the voice is not input for a preset time or the remote control apparatus 100 is restored to an original state is satisfied (S880), the microphone unit 110 is restored to an inactivation state (S890).

Accordingly, when the remote control apparatus 100 is not used, the movement is not detected or the voice is not input, Thus, battery consumption is reduced.

In the embodiments of FIGS. 7 and 8, after use intention is detected, a movement detector is activated. Alternatively, both the movement detector 120 and the detector 170 may be activated to determine whether a condition is satisfied. For example, when a condition, in which the remote control apparatus 100 moves by a preset angle or more and a proximity detection sensor detects the user approach is satisfied within a predetermined time, the controller 130 may activate the microphone unit 110.

According to another embodiment, the controller 130 of the remote control apparatus 100 may control operations of various components according to whether the movement detector 120 is activated.

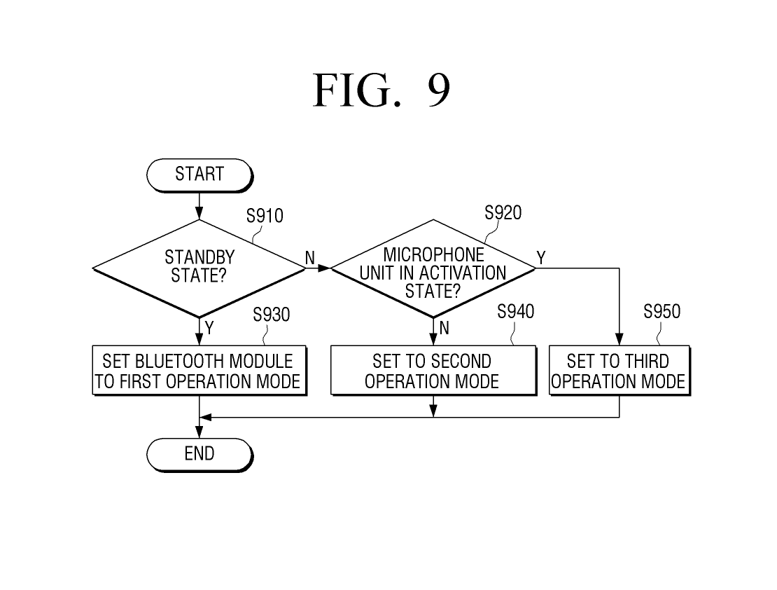

FIG. 9 is a flowchart for explanation of an embodiment of control of an operation of the communication unit 140.

As described above, the communication unit 140 may transmit the voice input through the activated microphone unit 110 or a remote controller signal corresponding to the voice to an external device. Further, the communication unit 140 may communicate with an external device, that is, the display apparatus 200 in the case of FIG. 1 using various communication methods such as Bluetooth, WiFi, Zigbee, etc.

FIG. 9 illustrates a case in which the communication unit 140 includes a Bluetooth module. The Bluetooth module may operate in a plurality of operation modes.

Referring to FIG. 9, in a standby state in which the remote control apparatus 100 is not used (S910), an operation mode of the Bluetooth module is set to a first operation mode for energy saving (S930). Further, the first operation mode may be a mode in which an external device and the remote control apparatus 100 is disconnected or a minimum connection therebetween is maintained to minimize power consumption.

Although use intention of a user with respect to the remote control apparatus 100 is detected, when the microphone unit 110 is inactivated (S920), the controller 130 may set the operation mode of the Bluetooth module to a second operation mode (S940). The second operation mode may refer to a mode appropriate for performing a general function of the remote control apparatus 100. In other words, in a general case, when a button is pushed, the remote control apparatus 100 transmits manipulation information of the button. Buttons included in the remote control apparatus 100 may include a direction button, a number button, a setting button, a character button, a volume control button, a channel control button, etc., which have predetermined control codes, respectively. The size of each control code is not large. Thus, the second operation mode may use a bandwidth for transmitting button manipulation information, i.e., the size of a control code corresponding to the selected button.

When the microphone unit 110 is activated, the controller 130 may determine that a current mode is a voice input mode. Accordingly, the controller 130 set an operation mode of the Bluetooth module to a third operation mode. In the third operation, the communication unit 140 may transmit input user voice information as well as button manipulation information. Thus, the third operation mode may use a wider communication bandwidth than the second operation mode. In addition, in the third operation mode, the controller 130 may encode and transmit voice input by a user for security. Thus, the controller 130 may additionally active an encoding circuit.

As described above, according to use intention of the user and movement of a remote control apparatus, an operation of the communication unit 140 may be changed.

According to another embodiment, the communication unit 140 may include both a first communication unit (not shown) for transmitting voice and a second communication unit (not shown) for transmitting the button manipulation information. The second communication unit may be embodied as an infrared (IR) lamp for transmitting a control signal as an IR signal corresponding to the button manipulation. The first communication unit may be embodied as various components such as a Bluetooth module, a WiFi chip, a Zigbee module, etc., for transmitting voice. In this case, the controller 130 may always activate the second communication unit and may control the first communication unit to be activated only when the microphone unit 110 is activated.

As described above, voice input to the remote control apparatus 100 may be used as a voice command for controlling an operation of an external device or as a user input in a conversation service.

The remote control apparatus 100 may provide various information associated with voice input through the display apparatus 200 in conjunction with the display apparatus 200.

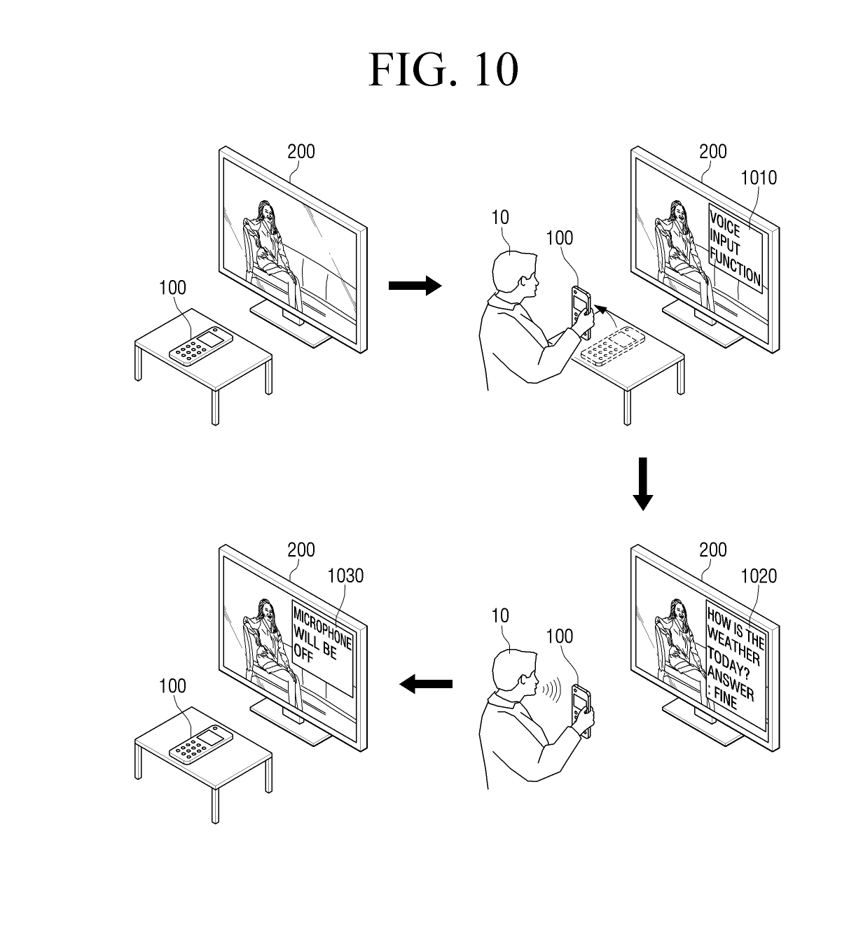

FIG. 10 is a diagram for explanation of an example of an operation of the display apparatus 200 that operates in conjunction with the remote control apparatus 100. FIG. 10 illustrates an example of a process using a conversation service via the remote control apparatus 100.

Referring to FIG. 10, when the display apparatus 200 is turned on, if the user 10 raises the remote control apparatus 100 positioned at a random location, the controller 130 determines whether movement of the remote control apparatus 100 satisfies a preset condition. When the preset condition is satisfied, the controller 130 activates the microphone unit 110 and notifies the display apparatus 200.

Accordingly, the display apparatus 200 converts a current mode into a voice input mode for receiving the voice input and displays a message 1010 corresponding thereto on a screen.

In this state, when the user 10 inputs the voice, the remote control apparatus 100 transmits the input voice to the display apparatus 200. FIG. 10 illustrates a case in which a sentence “How is the weather today?” is input. The display apparatus 200 parses the input sentence and displays a message 1020 corresponding thereto. Further, the display apparatus 200 analyzes each syllable of the sentence pronounced by the user 10 and specifies postpositions. In addition, words and predicates are differentiated based on the postpositions, the differentiated words and predicates are compared with commands of a database, and determines whether the sentence is a command. The display apparatus 200 extracts a command and a keyword, searches for data from a storage unit of the display apparatus 200 or an external server using the extracted command and keyword, and then generates an answer sentence in response to a user voice based on the search result. As illustrated in FIG. 10, the display apparatus 200 may display voice information pronounced by the user 10 together with an answer sentence 1020 in response to the voice.

When the user 10 does not use the remote control apparatus 100 again, the remote control apparatus 100 inactivates the microphone unit 110. Before the microphone unit 110 is inactivated, the controller 130 of the remote control apparatus 100 may notify the display apparatus 200 that a microphone is to be inactivated. Upon being notified of this fact by the remote control apparatus 100, the display apparatus 200 displays a message 1030 indicating this fact (e.g., “microphone will be off”). The user 10 may check the message 1030 and may re-manipulate the remote control apparatus 100 in order to continuously maintain the microphone unit 110 in an activation state.

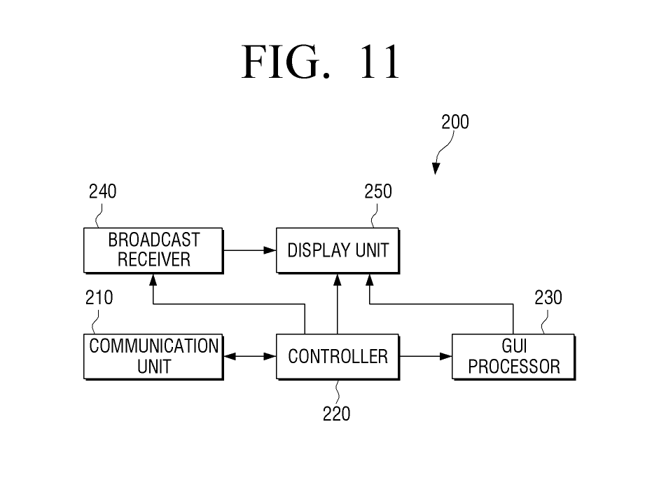

FIG. 11 is a block diagram illustrating the display apparatus 200 according to an embodiment. Referring to FIG. 11, the display apparatus 200 includes a communication unit 210, a controller 220, a graphic user interface (GUI) processor 230, a broadcast receiver 240, and a display unit 250.

The communication unit 210 receives various signals from the remote control apparatus 100. Further, the communication unit 210 may receive a remote controller signal according to button manipulation of the remote control apparatus 100, a user voice signal input through the remote control apparatus 100, etc.

The controller 220 controls an operation of the display apparatus 200 according to a signal input through the communication unit 210. For example, upon receiving a remote controller signal for a channel change, the controller 220 controls the broadcast receiver 240 according to the remote controller signal and tunes a channel selected by the user. In addition, when a conversation service is started, when a user voice signal is input through the communication unit 210, the controller 220 performs search based on the user voice signal and displays the search result on the display unit 250. Processing the user voice in a conversation service procedure has already been described. Thus, the conversation service procedure will not be repeated.

The GUI processor 230 is a command for generating various GUIs and providing the GUIs to the display unit 250. The GUI processor 230 calculates an attribute value such as a coordinate value, a shape, a size, color, and so on for displaying a GUI according to a preset layout. Then, the GUI processor 230 generates a GUI based on the calculated attribute value. The generated GUI is provided to the display unit 250. In particular, when the microphone unit 110 of the remote control apparatus 100 is activated or inactivated, the GUI processor 230 generates a GUI for indicating this fact and provides the GUI to the display unit 250.

The broadcast receiver 240 is a component for receiving and processing a signal transmitted through a broadcast station or other IP networks. The broadcast receiver 240 may include various signal processing circuits such as a demodulator, an equalizer, a synchronizer, a decoder, etc. The broadcast receiver 240 separates a video signal included in a broadcast signal and generates a video frame based on the video signal. The generated video frame is provided to the display unit 250.

The display unit 250 may overlap the GUI provided by the GUI processor 230 and the video frame processed by the broadcast receiver 240 to display the overlapped images as one image.

Although FIG. 10 illustrates an embodiment in which a displayed message states that a microphone unit is to be inactivated in a conversation service procedure, the display apparatus 200 may show a state of the microphone unit using various methods.

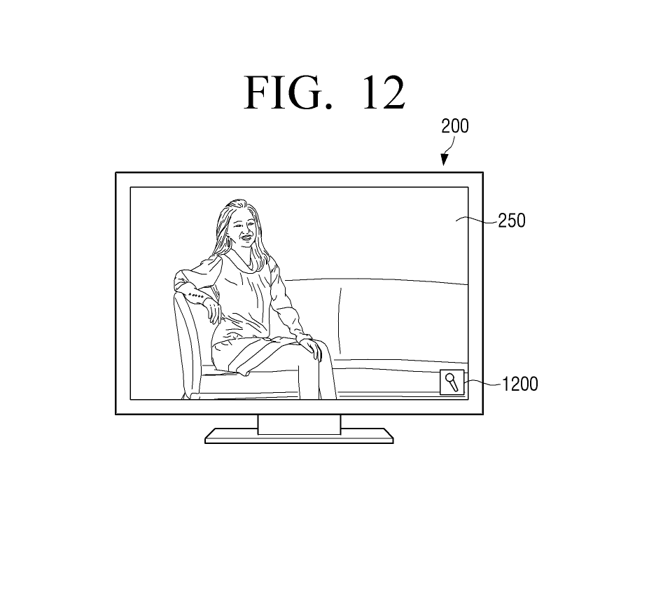

FIG. 12 is a diagram illustrating an operation of the display apparatus 200 according to another embodiment. Referring to FIG. 12, when the microphone unit 110 of the remote control apparatus 100 is activated, the display apparatus 200 may display an icon 1200 corresponding to the microphone unit 110 on one region of a screen. Thus, based on the icon 1200, the user may easily recognize that a current state is a state in which voice can be input. When an event occurs, for example, when the microphone unit 110 of the remote control apparatus 100 is not used for a predetermined time or more, the remote control apparatus 100 is restored to an original location, or no movement of the remote control apparatus 100 is detected, the controller 220 of the display apparatus 200 may control the GUI processor 230 such that the icon 1200 blinks for a predetermined time and disappears. In other words, when the microphone unit 110 is inactivated, the icon 1200 is not displayed.

A message or icon indicating a state of the microphone unit 110 may be displayed on the remote control apparatus 100, as well as the display apparatus 200.

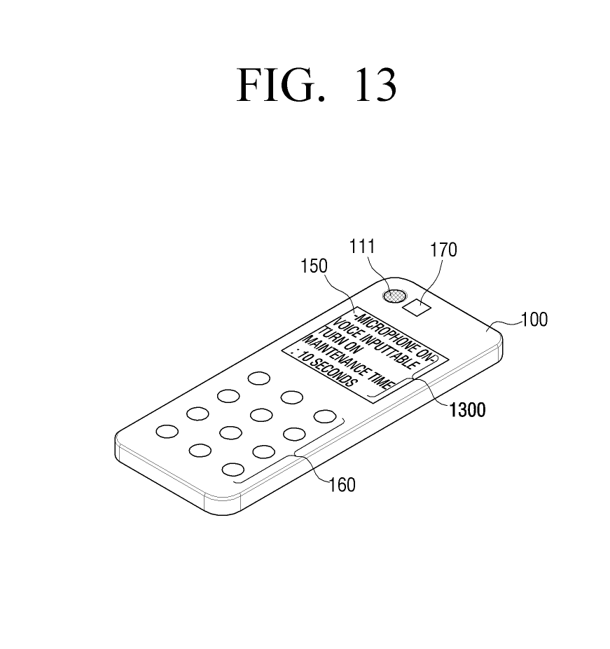

FIG. 13 is a diagram illustrating an operation of the remote control apparatus 100 according to an embodiment. Referring to FIG. 13, when the microphone unit 110 is activated, the controller 130 displays a message 1300 indicating that voice can be input through the microphone 111 on the display unit 150. In this case, the controller 130 may also display a time when the microphone unit 110 is maintained in an activation state. FIG. 13 illustrates a case in which 10 seconds correspond to a unit time. When user input is input to the controller 130, the controller 130 may reset maintenance time to update the time to 10 seconds. On the other hand, when 10 seconds elapse without input of user voice, the controller 130 controls the microphone unit 110 to be in an inactivation state again.

FIG. 13 illustrates a case in which a visual message is displayed, but embodiments are not limited thereto.

In other words, FIGS. 3, 7, and 13 exemplify a case in which the remote control apparatus 100 includes a display unit. However, the display unit is not a necessary portion and thus may be omitted as necessary. When a speaker is provided in the remote control apparatus 100 instead of the display unit, the remote control apparatus 100 of FIG. 13 may output this message in the form of voice massage.

As described above, according to the above embodiments, voice may be input via a microphone included in the remote control apparatus 100 in an effective manner, Therefore, unnecessary noise is prevented from being input. Further, excessive battery consumption is prevented.

The voice inputting method of a remote control apparatus or a control method of a display apparatus according to the aforementioned embodiments may be coded to software and stored in a non-transitory readable medium. The non-transitory readable medium may be installed in various devices and used.

Further, a program code for execution of a control method may be stored in the non-transitory readable medium and provided. The control method includes detecting movement of a remote control apparatus, activating a microphone unit when the movement of the remote control apparatus satisfies a reset condition, transmitting voice input through the microphone unit to an external device, and inactivating the microphone unit when the microphone unit is activated, if voice is not input for a preset time or the remote control is restored to an original state.

The non-transitory computer readable medium is a medium that semi-permanently stores data and from which data is readable by a device, but not a medium that stores data for a short time, such as register, a cache, a memory, and the like. Further, the aforementioned various applications or programs may be stored in the non-transitory computer readable medium, for example, a compact disc (CD), a digital versatile disc (DVD), a hard disc, a bluray disc, a universal serial bus (USB), a memory card, a read only memory (ROM), etc., and may be provided.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims. Many alternatives, modifications, and variations will be apparent to those skilled in the art.

What is claimed is:

1. A remote control apparatus comprising:
a movement detector which is configured to detect a movement of the remote control apparatus;
a microphone which is configured to receive a voice input;
a controller which is configured to activate the microphone in response to the remote control apparatus moving for a preset first time by at least a threshold angle; and
a communicator which is configured to transmit the voice input to an external device in response to the voice input being input through the activated microphone.

2. The remote control apparatus as claimed in claim 1, wherein the controller is further configured to inactivate the microphone in response to the voice input not being input for a preset second time when the microphone is activated.

3. The remote control apparatus as claimed in claim 1, wherein the controller is further configured to inactivate the microphone in response to the remote control apparatus being restored to a state before the movement of the remote control apparatus occurs.

4. The remote control apparatus as claimed in claim 1, further comprising:
a detector which is configured to detect a use intention with respect to the remote control apparatus,
wherein the controller is further configured to inactivate the movement detector in a standby state, and activate the movement detector in response to the use intention being detected.

5. The remote control apparatus as claimed in claim 4, wherein:
the detector is further configured to detect at least one of a user touch on the remote control apparatus, a user approach to the remote control apparatus, a button input, and a preset user motion, and
the controller is further configured to determine that there is the use intention in response to at least one of the user touch on the remote control apparatus, the user approach to the remote control apparatus, the button input, and the preset user motion occurring.

6. The remote control apparatus as claimed in claim 1, further comprising:
a proximity detection sensor which is disposed at one side of the microphone and configured to detect a user approach to the remote control apparatus,
wherein the controller is further configured to activate the microphone in response to the proximity detection sensor detecting the user approach and the remote control apparatus moving for a first time by at least the threshold angle.

7. The remote control apparatus as claimed in claim 1, wherein:
the communicator comprises a Bluetooth module; and
the controller is further configured to set an operation mode of the Bluetooth module to a first operation mode for energy saving in a standby state, set the operation mode of the Bluetooth module to a second operation mode for transmitting button manipulation information in response to the microphone being inactivated, and set the operation mode of the Bluetooth module to a third operation mode for transmitting button manipulation information and input voice information in response to the microphone being activated.

8. The remote control apparatus as claimed in claim 1, further comprising:
a display unit,
wherein the controller is further configured to activate the microphone in response to the remote control apparatus rotating by at least the threshold angle for the preset first time in a direction away from a surface of the remote control apparatus, on which the display unit is disposed.

9. The remote control apparatus as claimed in claim 1, wherein the controller is further configured to activate the microphone in response to the remote control apparatus rotating by at least threshold angle for the preset first time in a direction away from a surface of the remote control apparatus, on which the microphone is disposed.

10. A voice inputting method of a remote control apparatus, the method comprising:
detecting a movement of the remote control apparatus using a sensor; and
activating a microphone in response to the remote control apparatus moving for a preset first time by at least the threshold angle; and
transmitting a voice input through the microphone to an external device,
wherein the sensor is included in the remote control apparatus.

11. The method as claimed in claim 10, further comprising inactivating the microphone in response to the voice not being input for a preset second time when the microphone is activated.

12. The method as claimed in claim 10, further comprising inactivating the microphone in response to the remote control apparatus being restored to a state before the movement of the remote control apparatus occurs.

13. The method as claimed in claim 10, further comprising:
detecting a use intention with respect to the remote control apparatus; and
inactivating the sensor in a standby state, and activating the sensor to detect the movement of the remote control apparatus in response to the use intention being detected.

14. The method as claimed in claim 13, wherein the detecting the use intention comprises determining that there is the use intention in response at least one of a user touch on the remote control apparatus, a user approach to the remote control apparatus, a button input, and a preset user motion occurring.

15. The method as claimed in claim 10, wherein:
the remote control apparatus comprises a Bluetooth module; and
the method further comprises:
setting an operation mode of the Bluetooth module to a first operation mode for energy saving in a standby state;
setting the operation mode of the Bluetooth module to a second operation mode for transmitting button manipulation information in response to the microphone being inactivated; and
setting the operation mode of the Bluetooth module to a third operation mode for transmitting button manipulation information and input voice information in response to the microphone being activated.

16. The method as claimed in claim 10, wherein:
the remote control apparatus comprises a display unit; and
the activating of the microphone comprises activating the microphone in response to the remote control apparatus rotating by at least the threshold angle for the preset first time in a direction away from a surface of the remote control apparatus, on which the display unit is disposed.

17. The method as claimed in claim 10, wherein the activating of the microphone comprises activating the microphone in response to the remote control apparatus rotating by at least the threshold angle for the preset first time in a direction away from a surface of the remote control apparatus, on which the microphone is disposed.

18. A voice inputting method of a remote control apparatus including a Bluetooth module and a microphone, the method comprising:
detecting a standby state in which the remote control apparatus is not being used;
setting an operation of the Bluetooth module to an energy saving operation in response to detecting the standby state;
detecting an activation state of the microphone in response to not detecting the standby state;
setting an operation of the Bluetooth module to a button manipulation operation in response to detecting the microphone being inactivated; and
setting an operation of the Bluetooth module to a voice input and button manipulation operation in response to detecting the microphone being activated.

19. The method as claimed in claim 18, wherein the energy saving operation is an operation in which an external device and the remote control apparatus are disconnected from each other to minimize power consumption.

20. The method as claimed in claim 18, wherein the voice input and button manipulation operation is an operation in which the remote control apparatus transmits a voice input and manipulation information of a button in response to the button being pushed and the voice being input through the microphone.
